(19) United States
(12) Patent Application Publication
(10) Pub. No.: US 2014/0375774 A1
(43) Pub. Date: Dec. 25, 2014

(54) GENERATION DEVICE AND GENERATION METHOD

(71) Applicant: FUJITSU LIMITED, Kawasaki-shi (JP)

(72) Inventors: Chikara IMAJO, Fukuoka (JP); Koji TAKATA, Fukuoka (JP)

(21) Appl. No.: 14/480,239

(22) Filed: Sep. 8, 2014

Related U.S. Application Data
(63) Continuation of application No. PCT/JP2012/058757, filed on Mar. 30, 2012.

(51) Int. Cl. H04N 13/02

(52) U.S. Cl. CPC H04N 13/0239
USPC 348/47

(57) ABSTRACT

A generation device includes a processor configured to execute a process including: acquiring a plurality of picture signals each including two images between which a position of an object in the two images differs in accordance with a parallax; changing the parallax by relatively moving the two images in a display area; generating an image for the display area by acquiring, with respect to an image moved in the display area out of the two images, an image of a part corresponding to an area in which the image is not included in the display area from the other image out of the two images and setting the acquired image in the area; and outputting the generated image for the display area.

### CROSS-REFERENCE TO RELATED APPLICATION

This application is a continuation of International Application No. PCT/JP2012/058757, filed on Mar. 30, 2012 and designating the U.S., the entire contents of which are incorporated herein by reference.

### FIELD

The embodiment discussed herein is related to a generation device and a generation method.

### BACKGROUND

There is known a technology for generating a stereoscopic image for displaying a stereoscopic picture from stereo images taken with multiple image pickup devices.

The stereo images here means, for example, a pair of two images with a predetermined parallax. Furthermore, the image pickup devices include, for example, digital cameras, cameras installed in mobile terminals, and cameras installed in personal computers (PCs), etc.

Out of scenes of a stereoscopic picture, a scene in which an object included in the stereoscopic picture makes a sudden movement due to sudden movement of the image pickup devices and a scene in which an object close to the image pickup devices moves, etc. may cause problems, such as making a user feel discomfort.

As one of the causes of user's feeling of discomfort, a parallax may be too large. Accordingly, technologies for reducing user's discomfort have been proposed. For example, a device changes a parallax of an object by relatively moving two images composing stereo images in a display area so as to reduce the parallax according to user's instruction.
Patent document 1: Japanese Laid-open Patent Publication No. 11-355808
Patent document 2: Japanese Laid-open Patent Publication No. 2004-221700
Patent document 3: Japanese Laid-open Patent Publication No. 2003-18619

However, the above-described conventional technology has a problem that the quality of a displayed image is degraded. FIG. 11 is a diagram for explaining an example of a conventional technology. In the example of FIG. 11, an image 91 for the right eye is displayed in a display area 90. Furthermore, in the example of FIG. 11, an image 92 for the left eye is displayed in a display area 90. Moreover, in the example of FIG. 11, a reference numeral 93 denotes the magnitude of a parallax between the image 91 and the image 92. In such a case, when the magnitude of the parallax has been specified by a user, and the user has issued an instruction to reduce the magnitude of the parallax, in the conventional technology, as illustrated in the example of FIG. 11, the image 91 is moved to the left in FIG. 11 in the display area 90 so that the magnitude of the parallax 93 becomes the specified magnitude. Furthermore, in the conventional technology, as illustrated in the example of FIG. 11, the image 92 is moved to the right in FIG. 11 in the display area 90 so that the magnitude of the parallax 93 becomes the specified magnitude.

At this time, as illustrated in the example of FIG. 11, an area 94 in which the image 91 is not included is generated in the display area 90. Furthermore, an area 95 in which the image 92 is not included is generated in the display area 90. Therefore, in the conventional technology, the areas 94 and 95 may be painted in black. Accordingly, in the conventional technology, the quality of a displayed image is degraded.

### SUMMARY

According to an aspect of an embodiment, a generation device includes a processor configured to execute a process including: acquiring a plurality of picture signals each including two images between which a position of an object in the two images differs in accordance with a parallax; changing the parallax by relatively moving the two images in a display area; generating an image for the display area by acquiring, with respect to an image moved in the display area out of the two images, an image of a part corresponding to an area in which the image is not included in the display area from the other image out of the two images and setting the acquired image in the area; and outputting the generated image for the display area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a system to which a generation device according to an embodiment is applied;

FIG. 2 is a diagram illustrating an example of the data structure of a corresponding position information DB;

FIG. 3 is a diagram illustrating an example of a correspondence relation between a block of an image for the left eye and a block of an image for the right eye indicated by content registered in the corresponding position information DB;

FIG. 4 is a diagram illustrating an example of correspondence relations between blocks of an image for the left eye and blocks of an image for the right eye indicated by contents registered in the corresponding position information DB;

FIG. 5A is a diagram for explaining an example of a process performed by a block matching processing unit;

FIG. 5B is a diagram for explaining the example of the process performed by the block matching processing unit;

FIG. 5C is a diagram for explaining the example of the process performed by the block matching processing unit;

FIG. 5D is a diagram for explaining the example of the process performed by the block matching processing unit;

FIG. 6 is a diagram for explaining an example of a process performed by a terminal device according to the embodiment;

FIG. 7 is a diagram for explaining an example of a process performed by the terminal device according to the embodiment;

FIG. 8 is a flowchart illustrating the procedure of a registering process according to the embodiment;

FIG. 9 is a flowchart illustrating the procedure of a generating process according to the embodiment;

FIG. 10 is a diagram illustrating a computer that executes a generation program; and

FIG. 11 is a diagram for explaining an example of a conventional technology.

### DESCRIPTION OF EMBODIMENTS

Preferred embodiments of the present invention will be explained with reference to accompanying drawings. Incidentally, this embodiment does not limit the technology discussed herein.

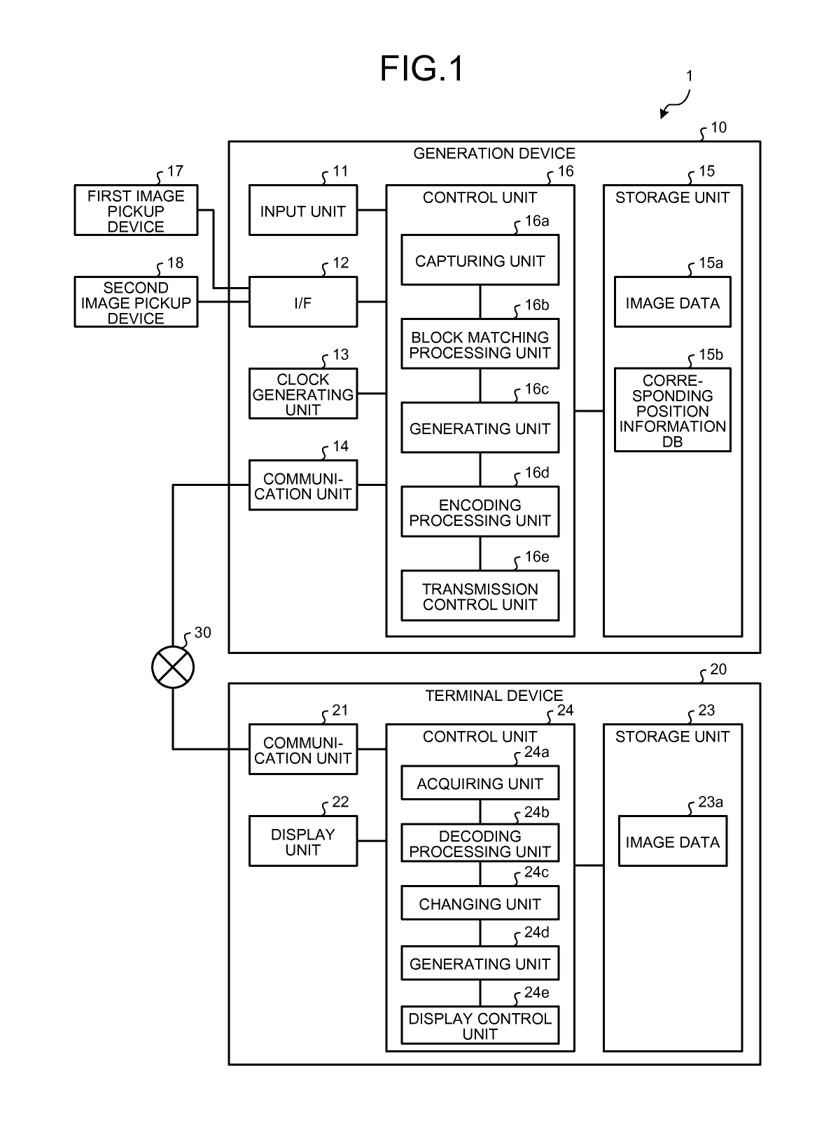

The generation device according to the embodiment is explained. FIG. 1 is a diagram illustrating an example of a configuration of a system to which the generation device according to the embodiment is applied. As illustrated in FIG. 1, a system 1 includes a generation device 10 and a terminal device 20. The generation device 10 and the terminal device 20 are connected via a network 30.

Configuration of Generation Device

As illustrated in FIG. 1, the generation device 10 includes an input unit 11, an interface (I/F) 12, a clock generating unit 13, a communication unit 14, a storage unit 15, and a control unit 16.

The input unit 11 inputs information to the control unit 16. For example, the input unit 11 receives an instruction from a user, and inputs the instruction to perform a generation process to be described later to the control unit 16. Device examples of the input unit 11 include a keyboard and a mouse, etc.

The I/F 12 is a communication interface for performing communication between first and second image pickup devices 17 and 18 and the control unit 16. For example, the I/F 12 is connected to the first and second image pickup devices 17 and 18. Then, the I/F 12 receives image data transmitted from the first and second image pickup devices 17 and 18, and transmits the received image data to the control unit 16.

The clock generating unit 13 generates a clock signal. For example, the clock generating unit 13 generates a clock signal for synchronizing image data transmitted from the first image pickup device 17 and image data transmitted from the second image pickup device 18, and transmits the generated clock signal to the control unit 16. A frequency of the clock signal is, for example, 27 MHz. However, a frequency of the clock signal is not limited to this, and any value can be adopted.

The communication unit 14 performs communication between the generation device 10 and the terminal device 20. For example, when the communication unit 14 has received encoded image data from the control unit 16, the communication unit 14 transmits the received image data to the terminal device 20 via the network 30.

The first and second image pickup devices 17 and 18 are placed at positions separated by a predetermined distance, respectively, and each acquire image data (frames) at a predetermined frame rate. Then, the first and second image pickup devices 17 and 18 transmit the acquired image data to the generation device 10. Accordingly, the generation device 10 can acquire the image data of a pair of two images, which are slightly different due to a predetermined parallax, at the predetermined frame rate. Incidentally, in the generation device 10, the image data is treated as a signal used in a picture; therefore, in the following description, a signal including “image data” may be referred to as a “picture signal”. Furthermore, in the following description, an image composed of “two images which are slightly different due to a predetermined parallax” may be referred to as “stereo images”. Moreover, it is assumed that an image acquired by the first image pickup device 17 is an image for the right eye, and an image acquired by the second image pickup device 18 is an image for the left eye.

The storage unit 15 stores therein various programs executed by the control unit 16. Furthermore, image data 15a is stored in the storage unit 15 by a capturing unit 16a to be described later. Moreover, the storage unit 15 stores therein a corresponding position information database (DB) 15b.

The image data 15a is explained. The image data 15a includes a variety of information in addition to image data acquired by the first and second image pickup devices 17 and 18. For example, the image data 15a includes “CLK counter information” on a clock count number which indicates the time at which image data has been captured. The “CLK counter information” is a count number that the capturing unit 16a has counted the number of clocks generated by the clock generating unit 13. The count number is added as “CLK counter information” to image data by the capturing unit 16a.

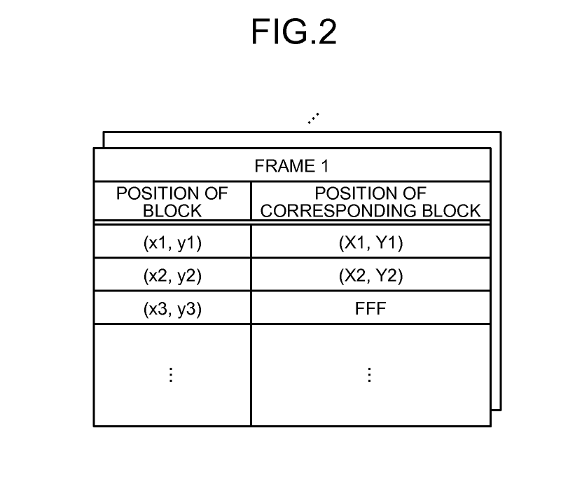

The corresponding position information DB 15b is explained. FIG. 2 is a diagram illustrating an example of the data structure of the corresponding position information DB 15b. In the example of FIG. 2, the corresponding position information DB 15b includes items: “position of block” and “position of corresponding block” with respect to each of blocks into which an image (a frame) for the left eye is divided. In the item “position of block”, coordinates of any one of four vertices of a block is registered. For example, coordinates of a top-left vertex out of four vertices of a block when an area of the block is represented in two-dimensional X-Y coordinates is registered in the item “position of block”.

Furthermore, in the item “position of corresponding block”, information indicating the position of a block of an image for the right eye which is similar to a block identified by coordinates registered in the item “position of block” is registered. For example, in the item “position of corresponding block”, a motion vector, where the above-mentioned coordinates of the top-left vertex registered in the item “position of block” is a starting point and coordinates of a top-left vertex of the block of the image for the right eye which is similar to the block identified by the coordinates registered in the item “position of block” is an end point, is registered.

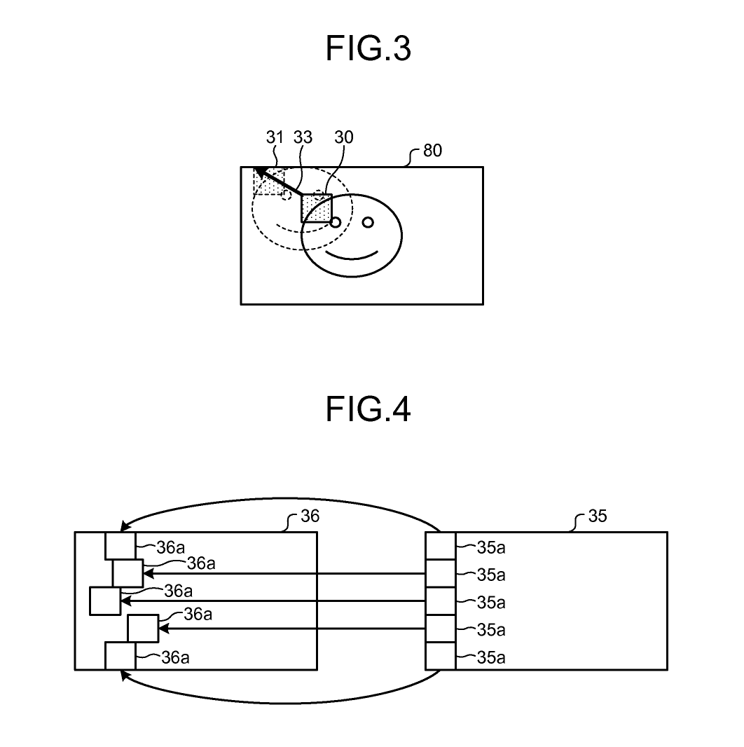

FIGS. 3 and 4 are diagrams illustrating an example of a correspondence relation between a block of an image for the left eye and a block of an image for the right eye indicated by content registered in the corresponding position information DB. FIG. 3 illustrates an example of a motion vector (X1(x7-x1), Y1(y7-y1)). A motion vector 33 in the example of FIG. 3 begins at coordinates (x1, y1) of a top-left vertex of a block 30 of an image for the left eye displayed in a display area 80. Furthermore, the motion vector 33 terminates at coordinates (x7, y7) of a top-left vertex of a block 31 of an image for the right eye displayed in the display area 80, which is similar to the block 30. In the case of the example of FIG. 3, as the first record in the example of FIG. 2 illustrates, the coordinates (x1, y1) and the motion vector (X1, Y1) are registered in the item “position of block” and the item “position of corresponding block”, respectively, by a generating unit 16c to be described later.

In this way, with respect to each of blocks in each frame, a block of an image for the left eye and its similar block of an image for the right eye are associated with each other and registered in the corresponding position information DB 15b by the generating unit 16c. Therefore, as illustrated in the example of FIG. 4, blocks 35a of an image 35 for the left eye are associated with their similar blocks 36a of an image 36 for the right eye, respectively. In the corresponding position information DB 15b, with respect to each frame, a block of an image for the left eye and its similar block of an image for the right eye are registered in an associated manner.

The storage unit 15 is, for example, a semiconductor memory device, such as a flash memory, or a storage device, such as a hard disk or an optical disk. Incidentally, the storage unit 15 is not limited to those types of storage devices, and can be a random access memory (RAM) or a read-only memory (ROM).

The control unit 16 includes an internal memory for storing therein programs, which define various processing procedures, and control data, and performs various processes with these. The control unit 16 includes the capturing unit 16a, a block matching processing unit 16b, the generating unit 16c, an encoding processing unit 16d, and a transmission control unit 16e.

The capturing unit 16a captures multiple picture signals each including stereo images composed of images between which a position of an object differs in accordance with a parallax. For example, the capturing unit 16a captures image data transmitted from the first and second image pickup devices 17 and 18 through the I/F 12.

Furthermore, the capturing unit 16a counts clock signals transmitted from the clock generating unit 13. For example, the capturing unit 16a detects the rising edge of a clock signal, and each time the capturing unit 16a has detected the rising edge, the capturing unit 16a increments a value of a counter by one. This counter may be referred to as the “timing counter” in the following description.

Then, the capturing unit 16a adds a value of the timing counter at the time when the capturing unit 16a has received the image data to the image data.

The block matching processing unit 16b performs a block matching process on stereo images captured by the capturing unit 16a, and detects a motion vector with respect to each block of an image for the left eye out of the stereo images composed of an image for the right eye and the image for the left eye. Furthermore, with respect to each block of the image for the left eye, the block matching processing unit 16b calculates a degree of similarity between blocks.

A process performed by the block matching processing unit 16b is explained with a concrete example. For example, the block matching processing unit 16b first divides an image indicated by image data for the left eye that the capturing unit 16a has captured and added a value of the timing counter thereto.

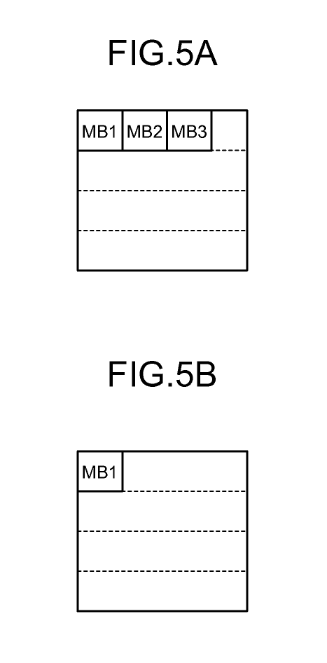

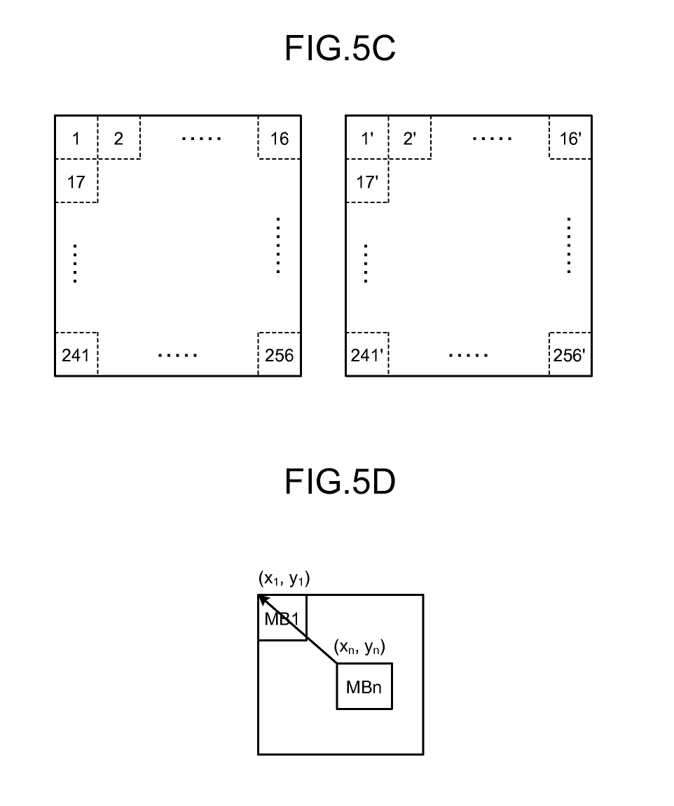

FIGS. 5A, 5B, 5C, and SD are diagrams for explaining an example of the process performed by the block matching processing unit. FIGS. SA and SB illustrate a case where the block matching processing unit 16b divides image data for the left eye into a plurality of blocks MB1, MB2, MB3, . . . . FIG. 5C illustrates an example where the number of pixels of each block is 256. Examples of image data illustrated in FIGS. 5A and 5B are image data transmitted from either the first image pickup device 17 or the second image pickup device 18. Furthermore, the image data illustrated in FIG. 5B is image data paired with the image data illustrated in FIG. 5A; the image data illustrated in FIGS. 5A and 5B are image data of stereo images.

The block matching processing unit 16b determines whether there are any blocks which have not been selected out of the blocks of the image data for the left eye. When there is a block which has not been selected, the block matching processing unit 16b selects one block which has not been selected out of the blocks of the image data for the left eye. Then, the block matching processing unit 16b calculates respective differences in pixel value between pixels 1 to 256 of the selected block and pixels 1′ to 256′ of each of blocks of the image data for the right eye. Then, the block matching processing unit 16b calculates the sum of the calculated differences with respect to each block of the image data for the left eye. The sum indicates a similarity; the smaller the value of the sum is, the higher the degree of similarity between an image indicated by the image data for the left eye and an image indicated by the image data for the right eye. In other words, when the similarity is smaller, the image for the left eye and the image for the right eye are more similar to each other. Therefore, the block matching processing unit 16b identifies a block of the image data for the right eye of which the calculated sum (similarity) is smallest.

The block matching processing unit 16b repeatedly performs the block matching process until all the blocks of the image data for the left eye have been selected. Then, the block matching processing unit 16b performs the block matching process on all image data with respect to each stereo-pair image data. Incidentally, in the following description, the block matching process performed on image data of a stereo pair may be referred to as “spatial-direction block matching”.

Then, when having performed the spatial-direction block matching, the block matching processing unit 16b calculates a difference vector between the position of the selected block of the image data of the image for the left eye and the position of the identified block of the image data of the image for the right eye which forms a stereo pair with the image for the left eye, and detects the calculated difference vector as a motion vector.

FIG. 5D illustrates an example where the block matching processing unit 16b has selected a block MBn of the image data for the left eye. Furthermore, FIG. 5D illustrates an example where the block matching processing unit 16b has identified a block MB1 of the image data for the right eye. In the example of FIG. 5D, the block matching processing unit 16b detects a difference vector (x₁-xₙ, y₁-yₙ) as a motion vector. Incidentally, in the example of FIG. 5D, the position of the block MBn of the image data for the left eye is represented by (xₙ, yₙ), and the position of the block MB1 of the image data for the right eye is represented by (x₁, y₁). The block matching processing unit 16b repeatedly performs such a process of detecting a motion vector until all the blocks of the image data of the image for the left eye have been selected. Then, the block matching processing unit 16b performs this motion-vector detecting process on all image data with respect to each stereo-pair image data.

The generating unit 16c generates corresponding position information in which the position of a block of an image for the left eye is associated with the position of its similar block of an image for the right eye, and registers the generated corresponding position information in the corresponding position information DB 15b.

A process performed by the generating unit 16c is explained with a concrete example. For example, when the spatial-direction block matching has been performed by the block matching processing unit 16b, the generating unit 16c determines whether a block of image data for the left eye selected by the block matching processing unit 16b is a block located at the end of an image. When the selected block is a block located at the end of an image, the generating unit 16c determines whether a similarity between the selected block of the image data for the left eye and a block of image data for the right eye identified by the block matching processing unit 16b is equal to or lower than a predetermined threshold A. Incidentally, as for the threshold A, an upper limit of similarity which can determine that two images are similar is set. When the degree of similarity is equal to or lower than the threshold A, the selected block of the image data for the left eye and the identified block of the image data for the right eye are similar, so the generating unit 16c performs the following process. That is, the generating unit 16c generates corresponding position information in which out of coordinates of four vertices of the selected block when an area of the selected block is represented in two-dimensional X-Y coordinates, coordinates (x, y) of a top-left vertex is associated with a motion vector (X, Y) calculated by the block matching processing unit 16b. On the other hand, when the similarity is not equal to or lower than the threshold A, the selected block of the image data for the left eye and the identified block of the image data for the right eye are not similar, so the generating unit 16c performs the following process. That is, the generating unit 16c generates corresponding position information in which out of coordinates of four vertices of the selected block when an area of the selected block is represented in two-dimensional X-Y coordinates, coordinates (x, y) of a top-left vertex is associated with information indicating that there is no corresponding block in the image for the right eye, for example, “FFF”. Then, the generating unit 16c registers the generated corresponding position information in the corresponding position information DB 15b. Each time the spatial-direction block matching has been performed by the block matching processing unit 16b, the generating unit 16c performs the process of registering corresponding position information in the corresponding position information DB 15b.

The encoding processing unit 16d performs, when having received an instruction to transmit image data 15a stored in the storage unit 15 from the terminal device 20 through the communication unit 14, an encoding process for encoding the image data 15a with a predetermined algorithm. At this time, the encoding processing unit 16d divides an image indicated by the image data 15a into a plurality of blocks in the same manner as described above, and performs the encoding process with respect to each of the blocks.

The transmission control unit 16e transmits a stream of blocks encoded by the encoding processing unit 16d to the communication unit 14 with respect to each stereo pair. At this time, the transmission control unit 16e refers to the corresponding position information DB 15b, and adds corresponding position information corresponding to each block to an encoded block and then transmits the block added with the corresponding position information to the communication unit 14. Accordingly, the communication unit 14 transmits the image data 15a of which the blocks have been encoded and added with corresponding position information by the encoding processing unit 16d to the terminal device 20.

The control unit 16 is an integrated circuit, such as an application specific integrated circuit (ASIC) or a field programmable gate array (FPGA), or an electronic circuit, such as a central processing unit (CPU) or a micro processing unit (MPU).

To return to FIG. 1, the terminal device 20 is a terminal that acquires a three-dimensional image from the generation device 10 and displays the acquired three-dimensional image. Various terminals, such as a cell-phone and a personal digital assistant (PDA), can be adopted as the terminal device 20. The terminal device 20 includes a communication unit 21, a display unit 22, a storage unit 23, and a control unit 24.

The communication unit 21 performs communication between the terminal device 20 and the generation device 10. For example, when the communication unit 21 has received a stream of encoded blocks from the generation device 10 with respect to each stereo pair, the communication unit 21 transmits the received stream of blocks of a stereo pair to the control unit 24. Furthermore, when the communication unit 21 has received an instruction to transmit image data 15a from an operation receiving unit (not illustrated) such as a mouse and keyboard that receives a user's instruction, the communication unit 21 transmits the received instruction to the generation device 10 via the network 30.

The display unit 22 displays a variety of information. For example, the display unit 22 is controlled by a display control unit 24e to be described later, and displays a three-dimensional image. That is, the display unit 22 outputs the three-dimensional image.

The storage unit 23 stores therein a variety of information. For example, image data 23a is stored in the storage unit 23 by an acquiring unit 24a to be described later.

The storage unit 23 is, for example, a semiconductor memory device, such as a flash memory, or a storage device, such as a hard disk or an optical disk. Incidentally, the storage unit 23 is not limited to those types of storage devices, and can be a RAM or a ROM.

The control unit 24 includes an internal memory for storing therein programs, which define various processing procedures, and control data, and performs various processes with these. The control unit 24 includes the acquiring unit 24a, a decoding processing unit 24b, a changing unit 24c, a generating unit 24d, and the display control unit 24e.

The acquiring unit 24a receives image data (frames) of a stereo pair from the communication unit 21, and stores the received image data 23a in the storage unit 23. Incidentally, the image data 23a is image data transmitted by the transmission control unit 16e.

The decoding processing unit 24b performs a decoding process for decoding the image data 23a.

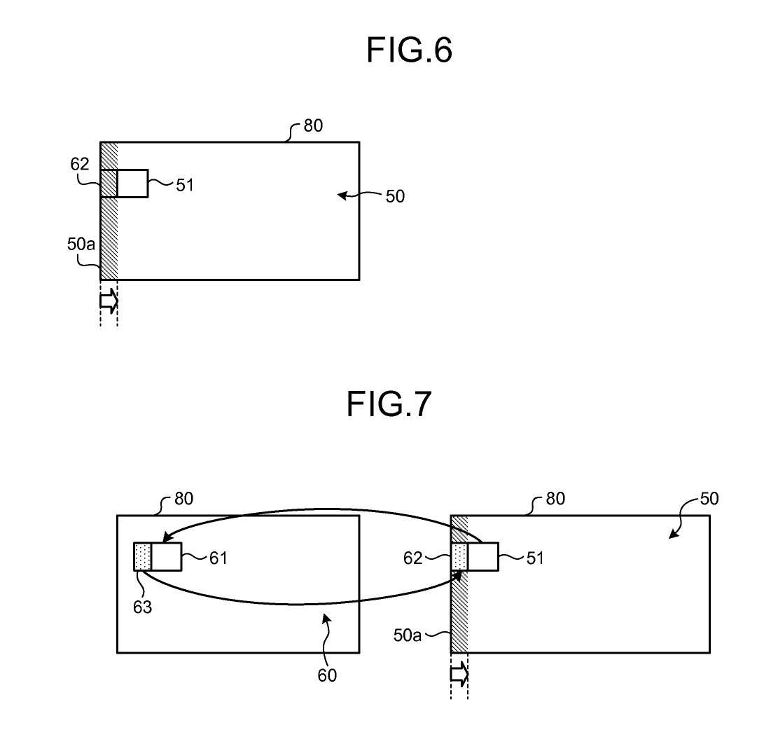

The changing unit 24c changes a parallax by relatively changing the positions of two images composing stereo images in a display area. For example, when the changing unit 24c has received an instruction to move an image for the left eye in a predetermined direction by a predetermined amount from the operation receiving unit, the changing unit 24c moves the image for the left eye in a display area in the predetermined direction by the predetermined amount. FIG. 6 is a diagram for explaining an example of a process performed by the terminal device according to the embodiment. FIG. 6 illustrates an example where the operation receiving unit has received an instruction to move an image 50 for the left eye displayed in a display area 80 to the right by a predetermined amount in the display area 80 from a user. In this case, the changing unit 24c moves the image 50 for the left eye to the right by the predetermined amount in the display area 80 as illustrated in FIG. 6. Incidentally, the changing unit 24c divides the image 50 for the left eye into a plurality of blocks in the same manner as described above, and moves each of the blocks on the basis of the instruction. That is, with respect to each block, the changing unit 24c calculates the position of a block within the display area 80 after the block is moved on the basis of the instruction, and sets the block in the calculated position within the display area 80. Here, when the image 50 has been moved in the display area 80 as illustrated in FIG. 6, an area 50a in which the image 50 is not included is generated. The area 50a is an area in which an image taken by the second image pickup device 18 is not included. In the following description, such an area may be referred to as a “non-shooting area”.

With respect to an image moved in a display area by the changing unit 24c out of two images composing stereo images, the generating unit 24d acquires an image of a part corresponding to a non-shooting area from the other image. Then, the generating unit 24d sets the acquired image in the non-shooting area, thereby generating an image of the display area.

For example, the generating unit 24d first determines whether a block set in the display area by the changing unit 24c is a block located at the end of the image for the left eye on the side of the non-shooting area. For example, in the example of FIG. 6, the generating unit 24d determines that a block 51 set in the display area 80 is a block located at the end of the image 50 for the left eye on the side of the non-shooting area 50a.

When the block set in the display area by the changing unit 24c is a block located at the end of the image for the left eye on the side of the non-shooting area, the generating unit 24d acquires corresponding position information added to this block. For example, in the case of FIG. 6, the generating unit 24d acquires corresponding position information added to the block 51. Then, the generating unit 24d determines whether there is a block corresponding to the block set in the display area. For example, the generating unit 24d determines whether information indicating that there is no corresponding block in the image for the right eye, for example, “FFF” is included in the corresponding position information added to the block. When information indicating that there is no corresponding block in the image for the right eye is included in the corresponding position information added to the block, the generating unit 24d determines that there is no block corresponding to the block set in the display area. On the other hand, when information indicating that there is no corresponding block in the image for the right eye is not included in the corresponding position information added to the block, the generating unit 24d determines that there is a block corresponding to the block set in the display area.

When there is a block corresponding to the block set in the display area, the generating unit 24d extracts an area adjacent to the block set in the display area from the non-shooting area. In the example of FIG. 6, the generating unit 24d extracts an area 62 adjacent to the block 51 from the non-shooting area 50a. Then, the generating unit 24d acquires an image of an area corresponding to the extracted area, i.e., an image of an area adjacent to the corresponding block that the generating unit 24d has determined there is in the image for the right eye. FIG. 7 is a diagram for explaining an example of a process performed by the terminal device according to the embodiment. FIG. 7 illustrates an example where there is a block 61 of an image 60 for the right eye which corresponds to the block 51 in FIG. 6. In the example of FIG. 7, the generating unit 24d acquires an image of an area 63 corresponding to the extracted area 62, i.e., an image of an area adjacent to the corresponding block 61 that the generating unit 24d has determined there is in the image 60 for the right eye. Then, the generating unit 24d copies the acquired image onto the extracted area. In the example of FIG. 7, the generating unit 24d copies the acquired image onto the extracted area 62. Accordingly, it is possible to suppress degradation of image quality.

On the other hand, when there is no block corresponding to the block set in the display area, the generating unit 24d performs the following process. That is, with respect to a part of the non-shooting area adjacent to the block set in the display area, the generating unit 24d expands an image of the block and performs image interpolation so that an image is interpolated into the part by using a publicly-known technology, such as a technology disclosed in Japanese Laid-open Patent Publication No. 2004-221700.

The generating unit 24d performs the above-described process with respect to each block, thereby generating an image for the left eye in the display area.

The display control unit 24e performs the following process when the generating unit 24d has performed the above-described process on all the blocks of the image for the left eye. That is, the display control unit 24e controls the display unit 22 to display a three-dimensional image with the use of the image for the left eye in the display area generated by the generating unit 24d and the image for the right eye decoded by the decoding processing unit 24b. In other words, the display control unit 24e outputs a three-dimensional image.

The control unit 24 is an integrated circuit, such as an application specific integrated circuit (ASIC) or a field programmable gate array (FPGA), or an electronic circuit, such as a central processing unit (CPU) or a micro processing unit (MPU).

Flow of Processing

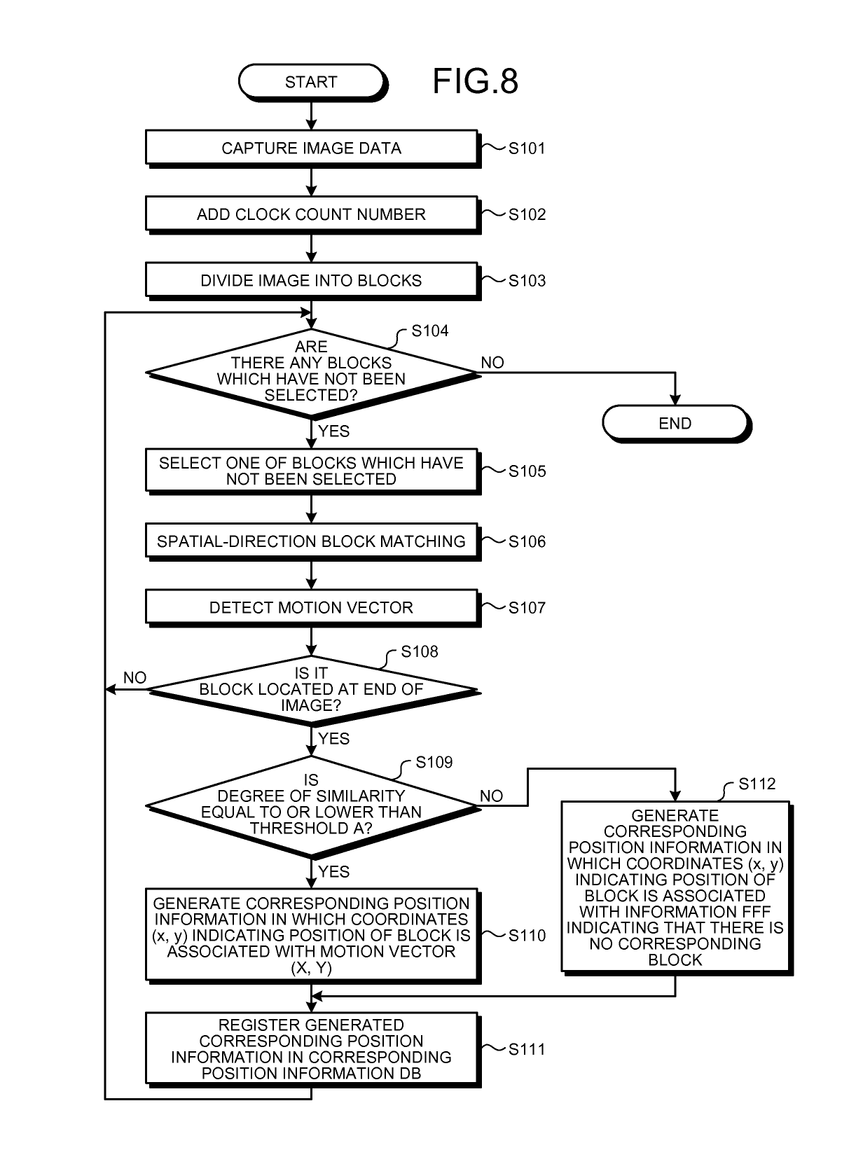

Subsequently, the flow of processing by the generation device 10 according to the present embodiment is explained. FIG. 8 is a flowchart illustrating the procedure of a registering process according to the embodiment. As the timing to perform this registering process, there are a variety of possible timing. For example, while the generation device 10 is powered on, each time image data has been transmitted from the first and second image pickup devices 17 and 18, the registering process is performed.

As illustrated in FIG. 8, the capturing unit 16a captures image data (Step S101). Then, the capturing unit 16a adds a value of the timing counter at the time when the capturing unit 16a has received the image data to the image data (Step S102). The block matching processing unit 16b divides an image indicated by the image data for the right or left eye that the capturing unit 16a has captured and added the value of the timing counter thereto (Step S103).

The block matching processing unit 16b determines whether there are any blocks which have not been selected out of a plurality of blocks in the captured image data (Step S104). When there are no blocks which have not been selected (NO at Step S104), the process is terminated.

On the other hand, when there is a block which has not been selected (YES at Step S104), the block matching processing unit 16b selects one block which has not been selected out of the blocks of the image data (Step S105). Then, the block matching processing unit 16b performs the above-described spatial-direction block matching (Step S106). Then, the block matching processing unit 16b detects a motion vector (Step S107).

Then, the generating unit 16c determines whether the block of the image data for the left eye selected by the block matching processing unit 16b is a block located at the end of the image (Step S108). When the selected block is not a block located at the end of the image (NO at Step S108), the process returns to Step S104. On the other hand, when the selected block is a block located at the end of the image (YES at Step S108), the generating unit 16c performs the following process. That is, the generating unit 16c determines whether a similarity between the selected block of the image data for the left eye and a block of the image data for the right eye identified by the block matching processing unit 16b is equal to or lower than a predetermined threshold A (Step S109).

When the similarity is equal to or lower than the threshold A (YES at Step S109), the generating unit 16c generates corresponding position information in which coordinates (x, y) of a top-left vertex of the selected block is associated with a motion vector (X, Y) (Step S110). Then, the process moves on to Step Sill. On the other hand, when the similarity is not equal to or lower than the threshold A (NO at Step S109), the generating unit 16c generates corresponding position information in which coordinates (x, y) of a top-left vertex of the selected block is associated with “FFF” (Step S112). Then, the generating unit 16c registers the generated corresponding position information in the corresponding position information DB 15b (Step S111), and the process returns to Step S104.

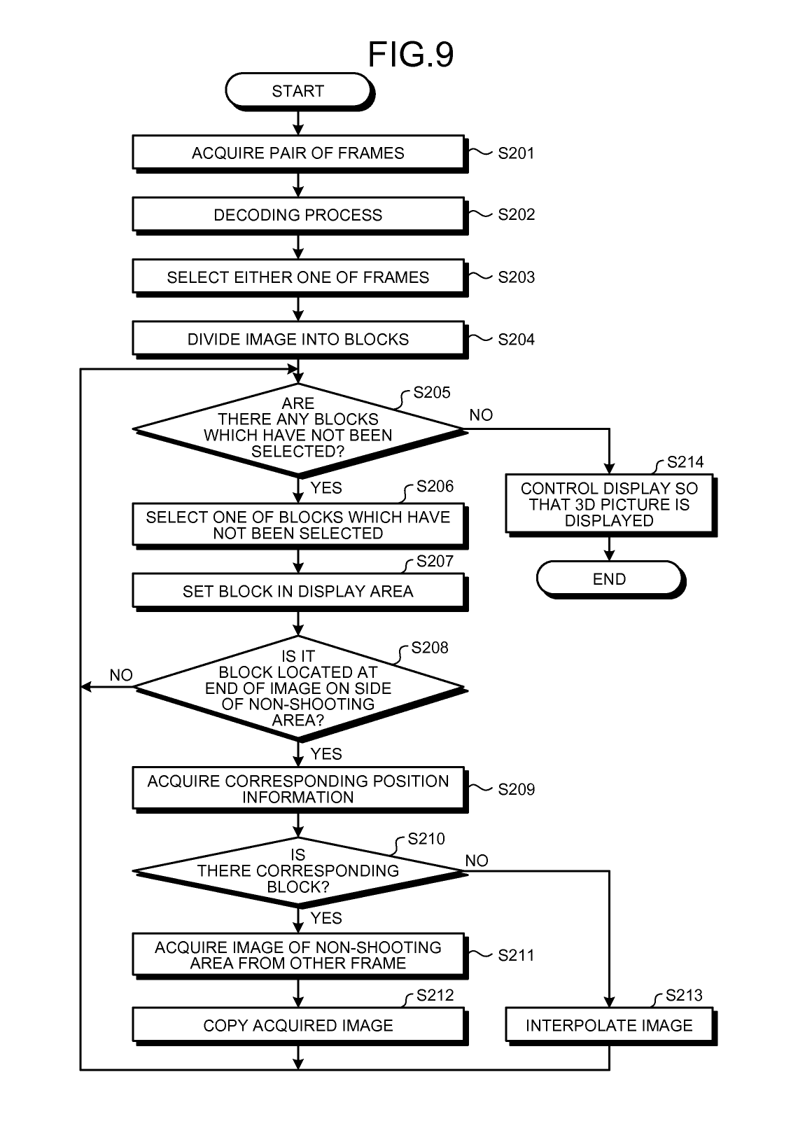

Subsequently, the flow of processing by the terminal device 20 according to the present embodiment is explained. FIG. 9 is a flowchart illustrating the procedure of a generating process according to the embodiment. As the timing to perform this generating process, there are a variety of possible timing. For example, while the terminal device 20 is powered on, each time the control unit 24 has received encoded image data of a stereo pair transmitted from the generation device 10, the generating process is performed.

As illustrated in FIG. 9, the acquiring unit 24a receives image data (frames) of a stereo pair from the communication unit 21, thereby acquiring the image data, and stores the acquired image data 23a in the storage unit 23 (Step S201). Then, the decoding processing unit 24b performs a decoding process for decoding the image data 23a (Step S202).

Then, the changing unit 24c selects image data for the left eye out of the image data of the stereo pair (Step S203). Then, the changing unit 24c divides an image indicated by the selected image data for the left eye into a plurality of blocks in the same manner as described above (Step S204). After that, the changing unit 24c determines whether there are any blocks which have not been selected in the plurality of blocks (Step S205). When there is a block which has not been selected (YES at Step S205), the changing unit 24c selects one block which has not been selected (Step S206). Then, the changing unit 24c calculates the position of the selected block within a display area after the block is moved on the basis of an instruction, and sets the selected block in the calculated position within the display area (Step S207).

Then, the generating unit 24d determines whether the block set in the display area by the changing unit 24c is a block located at the end of the image for the left eye on the side of a non-shooting area (Step S208). When the block set in the display area by the changing unit 24c is not a block located at the end of the image for the left eye on the side of the non-shooting area (NO at Step S208), the process returns to Step S205.

On the other hand, when the block set in the display area by the changing unit 24c is a block located at the end of the image for the left eye on the side of the non-shooting area (YES at Step S208), the generating unit 24d acquires corresponding position information added to this block (Step S209). Then, the generating unit 24d determines whether there is a block corresponding to the block set in the display area (Step S210).

When there is a block corresponding to the block set in the display area (YES at Step S210), the generating unit 24d extracts an area adjacent to the block set in the display area from the non-shooting area. Then, the generating unit 24d acquires an image of an area corresponding to the extracted area, i.e., an image of an area adjacent to the corresponding block that the generating unit 24d has determined there is in an image for the right eye (Step S211). Then, the generating unit 24d copies the acquired image onto the extracted area (Step S212), and the process returns to Step 6205.

On the other hand, when there is no block corresponding to the block set in the display area (NO at Step S210), the generating unit 24d performs the following process. That is, with respect to a part of the non-shooting area adjacent to the block set in the display area, the generating unit 24d expands an image of the block and performs image interpolation so that an image is interpolated into the part by using a publicly-known technology (Step S213), and the process returns to Step S205.

On the other hand, when there are no blocks which have not been selected (NO at Step S205), the display control unit 24e performs the following process. That is, the display control unit 24e controls the display unit 22 to display a three-dimensional image with the use of the image for the left eye in the display area generated by the generating unit 24d and the image for the right eye decoded by the decoding processing unit 24b (Step S214). Then, the process is terminated.

### Effects of Embodiment

As described above, the terminal device 20 according to the present embodiment changes a parallax by relatively changing the positions of two images composing stereo images in a display area. With respect to an image moved in the display area out of the two images composing the stereo images, the terminal device 20 acquires an image of a part corresponding to a non-shooting area from the other image. Then, the terminal device 20 sets the acquired image in the non-shooting area, thereby generating an image of the display area. After that, the terminal device 20 controls the display unit 22 to display a three-dimensional image with the use of the generated image for the left eye in the display area. Therefore, according to the terminal device 20, it is possible to suppress degradation of image quality.

The embodiment relating to the device according to the present invention is explained above; however, the present invention can be embodied in various different forms other than the above-described embodiment. Therefore, other embodiments included in the present invention are explained below.

For example, the device according to the present invention can perform a process performed on an image for the left eye in the above embodiment with respect to an image for the right eye, and perform a process performed on an image for the right eye with respect to an image for the left eye.

Furthermore, out of the processes described in the above embodiment, all or part of the process described as an automatically-performed process can be manually performed.

Moreover, respective processes at steps in each process described in the above embodiment can be arbitrarily subdivided or integrated depending on various loads and usage conditions, etc. Furthermore, some of the steps can be omitted.

Moreover, the order of respective processes at steps in each process described in the above embodiment can be changed depending on various loads and usage conditions, etc.

Furthermore, components of each device illustrated in the drawings are functionally conceptual ones, and do not necessarily have to be physically configured as illustrated in the drawings. That is, the specific forms of division and integration of components of each device are not limited to those illustrated in the drawings, and all or some of the components can be configured to be functionally or physically divided or integrated in arbitrary units depending on various loads and usage conditions, etc.

Generation Program

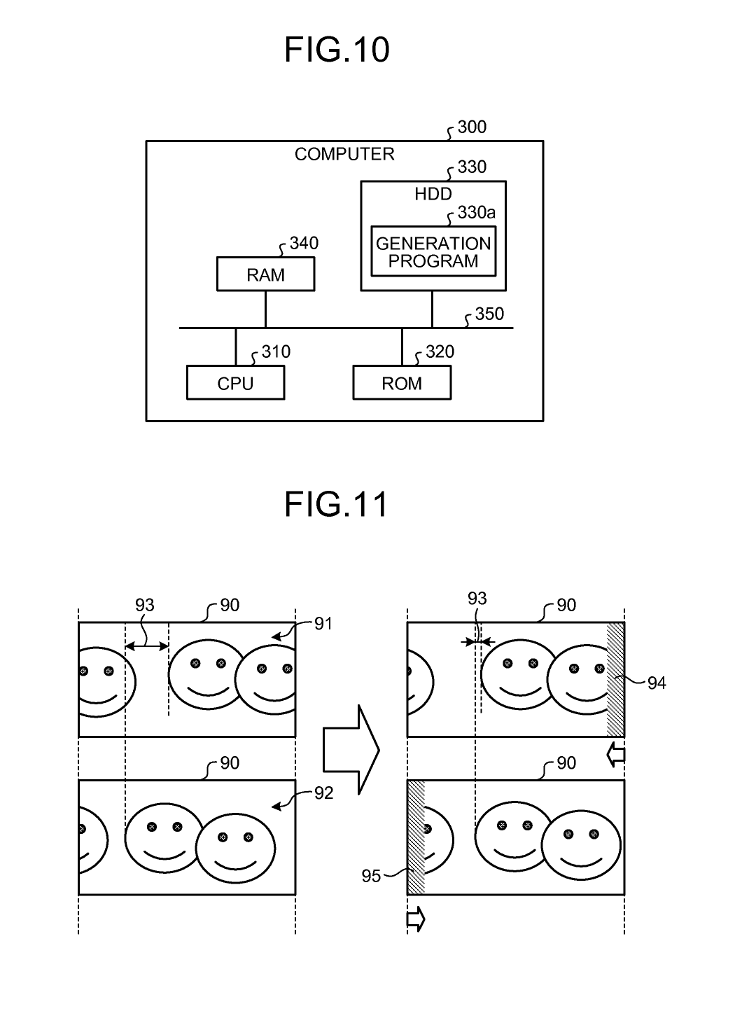

Furthermore, the generating process performed by the generation device 10 described in the above embodiment can be realized by causing a computer system, such as a personal computer or a workstation, to execute a program prepared in advance. An example of a computer that executes a generation program having the same functions as the generation device 10 described in the above embodiment is explained below with FIG. 10.

FIG. 10 is a diagram illustrating the computer that executes the generation program. As illustrated in FIG. 10, a computer 300 includes a central processing unit (CPU) 310, a read-only memory (ROM) 320, a hard disk drive (HDD) 330, and a random access memory (RAM) 340. These units 310 to 340 are connected through a bus 350.

A generation program 330a, which fulfills the same functions as the acquiring unit 24a, the decoding processing unit 24b, the changing unit 24c, the generating unit 24d, and the display control unit 24e described in the above embodiment, is stored in the HDD 330 in advance. Incidentally, the generation program 330a can be arbitrarily separated.

Then, the CPU 310 reads out the generation program 330a from the HDD 330, and executes the generation program 330a.

Furthermore, image data is saved on the HDD 330. The image data corresponds to the image data 23a.

Then, the CPU 310 reads out the image data from the HDD 330, and stores the read image data in the RAM 340. Furthermore, the CPU 310 executes the generation program 330a by using the image data stored in the RAM 340. Incidentally, all of data stored in the RAM 340 do not always have to be stored in the RAM 340; out of all the data, only data used in a process just has to be stored in the RAM 340.

Incidentally, the generation program 330a does not necessarily have to be stored in the HDD 330 from the beginning.

For example, the program can be stored in a “portable physical medium” such as a flexible disk (FD), a CD-ROM, a DVD, a magneto-optical disk, or an IC card to be inserted into the computer 300. Then, the computer 300 can read out the program from such a portable physical medium and execute the read program.

Furthermore, the program can be stored on “another computer (or a server)” connected to the computer 300 via a public line, the Internet, a LAN, or a WAN, etc. Then, the computer 300 can read out the program from the another computer (or the server) and execute the read program.

According to one aspect of a generation device discussed in the present application, the generation device can suppress degradation of image quality.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A generation device comprising:
a processor configured to execute a process including:
acquiring a plurality of picture signals each including two images between which a position of an object in the two images differs in accordance with a parallax;
changing the parallax by relatively moving the two images in a display area;
generating an image for the display area by acquiring, with respect to an image moved in the display area out of the two images, an image of a part corresponding to an area in which the image is not included in the display area from the other image out of the two images and setting the acquired image in the area; and
outputting the generated image for the display area.

2. The generation device according to claim 1, wherein
the process further includes acquiring information indicating a position of the other image corresponding to the area in the display area, and
the generating includes acquiring the image of the part corresponding to the area in the display area from the other image based on the acquired information.

3. A non-transitory computer-readable recording medium having stored therein a generation program causing a computer to execute a process comprising:
acquiring a plurality of picture signals each including two images between which a position of an object in the two images differs in accordance with a parallax;
changing the parallax by relatively moving the two images in a display area;
generating an image for the display area by acquiring, with respect to an image moved in the display area out of the two images, an image of a part corresponding to an area in which the image is not included in the display area from the other image out of the two images and setting the acquired image in the area; and
outputting the generated image for the display area.

4. A generation method implemented by a computer, the generation method comprising:
acquiring, using a processor, a plurality of picture signals each including two images between which a position of an object in the two images differs in accordance with a parallax;
changing, using the processor, the parallax by relatively moving the two images in a display area;
generating, using the processor, an image for the display area by acquiring, with respect to an image moved in the display area out of the two images, an image of a part corresponding to an area in which the image is not included in the display area from the other image out of the two images and setting the acquired image in the area; and
outputting the generated image for the display area.
